(19) United States
(12) Patent Application Publication
(10) Pub. No.: US 2023/0395905 A1
(43) Pub. Date: Dec. 7, 2023

(54) BATTERY

(71) Applicant: ZHUHAI COSMX BATTERY CO., LTD., Zhuhai (CN)

(72) Inventors: Donghui SHENG, Zhuhai (CN); Yingjie ZHANG, Zhuhai (CN); Ning PENG, Zhuhai (CN)

(73) Assignee: ZHUHAI COSMX BATTERY CO., LTD., Zhuhai (CN)

(21) Appl. No.: 18/451,252

(22) Filed: Aug. 17, 2023

Related U.S. Application Data
(63) Continuation of application No. PCT/CN2022/081082, filed on Mar. 16, 2022.

(30) Foreign Application Priority Data
Mar. 29, 2021 (CN) 202110332709.1

(51) Int. Cl. H01M 50/105; H01M 50/128; H01M 50/134

(52) U.S. Cl. CPC H01M 50/105; H01M 50/128; H01M 50/134; H01M 10/052

(57) ABSTRACT

Disclosed is a battery, including a battery cell body and a packaging housing. The packaging housing has an edge banding and a cavity, and the edge banding has a cross section. The edge banding extends upwards along a side surface of the battery cell body, a side surface, close to the battery cell body, of the edge banding is an inner side surface, and a side surface, away from the battery cell body, of the edge banding is an outer side surface. The cross section is provided with a first bonding body, and the first bonding body wraps the cross section, a part of the inner side surface and a part of the outer side surface of the edge banding. A lower edge of the first bonding body on the inner side surface is higher than a lower edge of the first bonding body on the outer side surface.

### CROSS-REFERENCE TO RELATED APPLICATIONS

This application is a continuation of International Application No. PCT/CN2022/081082, filed on Mar. 16, 2022, which claims priority to Chinese Patent Application No. 202110332709.1, filed on Mar. 29, 2021. The disclosures of the aforementioned applications are hereby incorporated by reference in their entireties.

### TECHNICAL FIELD

This application relates to the field of batteries, and in particular, to a battery.

### BACKGROUND

With the development trend of electronic products towards intelligence, integration, and lightweight, lithium batteries have advantages such as light weight, thin thickness, and reliable performance. In addition, since a pouch lithium battery has a thin and soft aluminum-plastic film on an outer housing, compared with a conventional metal outer housing battery, the pouch lithium battery has advantages such as easy processing and high energy density, and is widely applied to an electronic product.

An aluminum-plastic film for a pouch lithium battery is generally a composite film, the aluminum-plastic film includes an insulating protective layer, a metal layer, and an insulating heat sealing layer, and the metal layer is located between the insulating protective layer and the insulating heat sealing layer. In a conventional technology, during packaging of a pouch lithium battery, a composite film is folded together to completely wrap a lithium cell, and an electrode terminal of the lithium cell extends out. Then, a folded aluminum-plastic film is sealed by means of heat sealing, so that the insulating heat sealing layer of the aluminum-plastic film is fused to form an edge banding. Finally, an excess edge banding is cut off to remove the redundant part. There is a risk of short circuit caused by contact between a section of a metal layer exposed on the outer side and obtained after cutting and an external electronic component. In addition, remaining edge banding after cutting increases a width of the battery, occupies a volume space of the lithium battery and affects space utilization, resulting in a loss of energy density of the lithium battery.

Therefore, there is an urgent need to improve a battery, so that the battery can effectively ensure insulating performance of an edge banding and improve a space utilization rate of the battery.

### SUMMARY

The present application provides a battery, to at least solve technical problems that insulating performance of an edge banding of the battery is not ideal and a space utilization rate of the battery is low.

To achieve the foregoing objective, the present application provides a battery, including: a battery cell body and a packaging housing, where the packaging housing has an edge banding and a cavity for accommodating the battery cell body, and the edge banding has a cross section cut along a thickness direction of the edge banding. The edge banding extends upwards along a side surface of the battery cell body, a side surface, close to the battery cell body, of the edge banding is an inner side surface, and a side surface, away from the battery cell body, of the edge banding is an outer side surface. The cross section is provided with a first bonding body, and the first bonding body wraps the cross section, a part of the inner side surface of the edge banding, and a part of the outer side surface of the edge banding. A lower edge of the first bonding body on the inner side surface is higher than a lower edge of the first bonding body on the outer side surface.

According to the battery provided in the present application, the first bonding body wraps the cross section, thereby avoiding the risk of short circuit caused by contact between a section of a metal layer exposed on the outer side and obtained after cutting and an external electronic component, and improving insulation performance of the edge banding of the battery. A side, away from the battery cell body, of the first bonding body is exposed to the outside, and a lower edge of the first bonding body on the inner side surface is higher than a lower edge of the first bonding body on the outer side surface, so that the first bonding body exposed to the outside has a stronger abrasion resistance and bonding force, improving service life and usage stability of the battery.

In a possible implementation, a second bonding body is provided between the inner side surface of the edge banding and the side surface of the battery cell body. By means of the second bonding body, the inner side surface of the edge banding and the side surface of the battery cell body are bonded, so that a space volume occupied by the battery may be reduced, and energy density of the battery may be improved.

In a possible implementation, the lower edge of the first bonding body on the inner side surface is higher than a top end of the second bonding body.

In a possible implementation, the lower edge of the first bonding body on the outer side surface is higher than a top end of the second bonding body.

In a possible implementation, the lower edge of the first bonding body on the inner side surface is higher than a top end of the second bonding body, and the lower edge of the first bonding body on the outer side surface is higher than the top end of the second bonding body.

In a possible implementation, the second bonding body is formed by curing a binder by means of heating, moisture, air drying, light, or the like.

In a possible implementation, a height difference between a top end of the first bonding body and the lower edge of the first bonding body on the outer side surface is H1, and a numerical range of H1 is H1>0.05 mm.

In a possible implementation, a height difference between the top end of the first bonding body and the lower edge of the first bonding body on the inner side surface is H2, and a numerical range of H2 is H2>0.05 mm, and H2<H1.

In a possible implementation, a side, away from the battery cell body, of the first bonding body is an outer side of the first bonding body, and a distance, in an orthographic projection direction of the battery cell body, from an outer side end of the first bonding body to the outer side surface of the edge banding is L1, where a numerical range of L1 is 0<L1<0.3 mm.

In a possible implementation, a side, close to the battery cell body, of the first bonding body is an inner side of the first bonding body, and a distance, in the orthographic projection direction of the battery cell body, from an inner side end of the first bonding body to the inner side surface of the edge banding is L2, where a numerical range of the L2 is 0<L2<0.3 mm, and L1 is greater than L2. This ensures that the cross section of the edge banding is insulated, and also ensures that a size of the first bonding body does not affect the width of battery.

In a possible implementation, a height of a top end of the first bonding body is lower than or equal to a height of a top surface of the battery cell body.

In a possible implementation, a height of a top end of the first bonding body is greater than a height of the cross section of the edge banding, and a height difference between the top end of the first bonding body and the cross section of the edge banding is H4, where a numerical range of H4 is 0<H4<0.3 mm.

In a possible implementation, an angle between a lower edge of a side, away from the battery cell body, of the first bonding body and the edge banding is θ, and a numerical range of the angle θ is 0<θ<90°.

In a possible implementation, the packaging housing further has a top seal, the top seal is configured to wrap a top surface of the battery cell body, a height of a top end of the first bonding body is greater than a height of a top end of the top seal, and the first bonding body covers a partial region of the top seal.

In a possible implementation, a drawing force, along a direction perpendicular to the edge banding, between the first bonding body and the edge banding is greater than or equal to 0.01 kg/mm.

In a possible implementation, a hardness of the first bonding body is greater than 20 A.

In a possible implementation, the first bonding body is a binder cured by means of heating, moisture, air drying, or light, and the first bonding body has a shape of water drop, circle, oval, square, or U-shaped.

In a possible implementation, the battery includes a lithium battery.

The greater the drawing force between the first bonding body and the edge banding in the direction perpendicular to the edge banding, the greater the hardness of the first bonding body, and the stronger the wear resistance of the first bonding body. In this way, it may be avoided that the first bonding body is abraded to expose the metal layer of the cross section due to misoperation of a battery in a PACK process or a machine assembling process, or the like, thereby avoiding a short circuit of the battery and improving safety during use.

According to the battery provided in the present application, an edge banding has a higher sealing strength, and can effectively wrap a metal layer to seal the metal layer, thereby improving insulation performance of the edge banding of the battery; and the edge banding can also be compatible with batteries of different shapes, such as a square battery and a circular battery, which is convenient for flexibly production. A space occupied by the battery can be reduced as far as possible, energy density of the battery can be increased, a problem of wrinkling caused by an insulating adhesive paper in a conventional method can be avoided, and service life and stability in use of the battery are improved.

### BRIEF DESCRIPTION OF THE DRAWINGS

To describe the technical solutions in the embodiments of the present application or in the conventional technology more clearly, the following briefly describes the accompanying drawings required for describing the embodiments or the conventional technology. Apparently, the accompanying drawings in the following description show some embodiments of the present application, and a person of ordinary skill in the art may still derive other drawings from these accompanying drawings without creative efforts.

FIG. 1 is a schematic structural diagram of a battery according to an embodiment of the present application.

FIG. 2 is schematic structural diagram of a battery according to another embodiment of the present application.

FIG. 3 is a schematic structural diagram of a battery according to another embodiment of the present application.

FIG. 4 is a schematic structural diagram of a first bonding body of a battery according to an embodiment of the present application.

FIG. 5 is a schematic structural diagram of a first bonding body and a second bonding body of a battery according to an embodiment of the present application.

FIG. 6 is a projection diagram of a first bonding body of a battery in an orthographic projection direction of a battery cell body according to an embodiment of the present application.

FIG. 7 is a schematic structural diagram of a first bonding body and a cross section of a battery according to an embodiment of the present application.

FIG. 8 is a schematic diagram of a contact angle of a first bonding body of a battery in an orthographic projection direction according to an embodiment of the present application.

FIG. 9 is a schematic structural diagram of a packaging housing of a battery in a state before coating a first bonding body and a second bonding body according to an embodiment of the present application.

### DETAILED DESCRIPTIONS OF THE EMBODIMENTS

To make the objectives, technical solutions, and advantages of the present application clearer, the following clearly describes the technical solutions in the present application with reference to the accompanying drawings in the present application. Apparently, the described embodiments are some but not all of the embodiments of the present application. All other embodiments obtained by a person of ordinary skill in the art based on the embodiments of the present application without creative efforts shall fall within the protection scope of the present application.

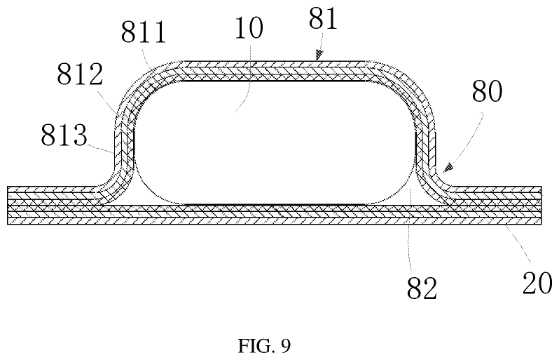

As shown in FIG. 9, a packaging housing 80 of a battery generally includes two layers of aluminum-plastic films 81, and a cavity 82 for accommodating a battery cell body 10 is formed between the two layers of aluminum-plastic films 81. The aluminum-plastic film is generally a composite film with a multilayer structure. Each aluminum-plastic film 81 includes an insulating protective layer 811 at an outer layer, a metal layer 812 at the middle layer, and an insulating heat sealing layer 813 at an inner layer, and the metal layer 812 is located between the insulating protective layer 811 and the insulating heat sealing layer 813. The aluminum-plastic films 81 are sealed by using a thermoplastic process to form an edge banding 20. The edge banding 20 has a width ranging from 5 mm to 30 mm, and occupies a specific volume when the battery is assembled. However, the edge banding 20 is not useful for a capacity of the battery, thereby reducing energy density of the battery.

In addition, the metal layer 812 of the aluminum-plastic film 81 in the edge banding 20 is exposed outside after being cut, and is easily contacted with an external electronic component, thereby causing a short circuit of the external electronic component, and posing a potential safety hazard.

In a conventional technology, in order to ensure insulation of the edge banding 20 and improve a space utilization rate of a battery, the edge banding 20 is generally bent twice along a side of the battery cell body 10, to wrap the metal layer 812, and then the edge banding 20 obtained after being bent twice is fastened to the battery cell body 10 by using an insulating adhesive paper; or the edge banding 20 is folded upwards along a side of the battery cell body 10 to adhere to the battery cell body 10 by using a binder or an insulating adhesive paper, and then the metal layer 812 in the edge banding of the battery is insulated by using an insulating adhesive paper. However, such a structure has the following problems: 1. after the edge banding 20 is bent twice, an overlapping part of the edge banding 20 will occupy a width space of the battery, affecting energy density of the battery; 2. a structure in which the edge banding 20 is bent twice or the edge banding 20 is fixed by means of an insulating adhesive paper cannot be applied to a battery with a special structure, such as an L-shaped battery with an arc edge banding; and 3. when an insulating adhesive paper is used to fix the edge banding 20, different sizes of adhesive papers are required for batteries of different modes, resulting in a requirement of a large number of different sizes of adhesive papers, a slow changeover process, incapability of flexible production, and a problem that the adhesive paper is easy to wrinkle.

In view of the foregoing background, the battery provided in the present application no longer uses adhesive paper, which facilitates product changeover and is applicable to different modes of batteries. A volume occupied by a battery can be reduced, and the energy density of the battery can be improved.

A battery provided in an embodiment of the present application is described below with reference to accompanying drawings.

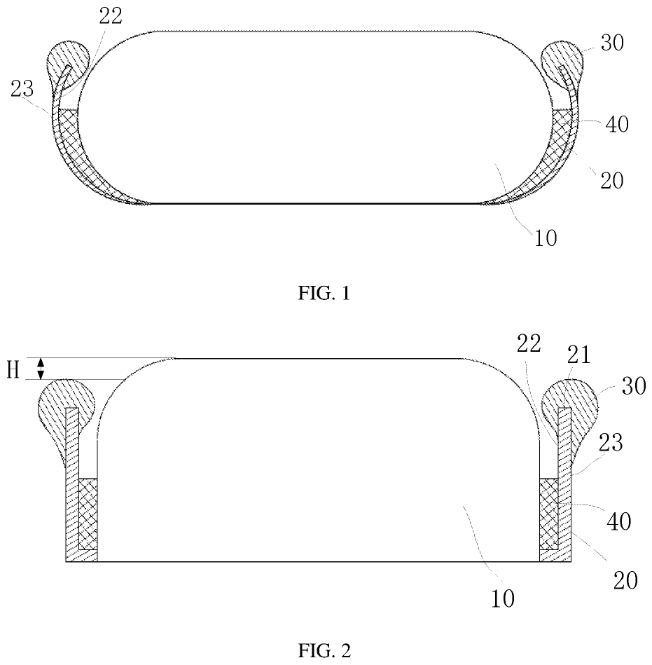

As shown in FIG. 1 and FIG. 2, a battery is provided, for example, a lithium battery, including: a battery cell body 10 and a packaging housing 80, where the packaging housing 80 has an edge banding 20 and a cavity 82 for accommodating the battery cell body 10, and the edge banding 20 has a cross section 21 cut along a thickness direction of the edge banding 20. The edge banding 20 extends upwards along a side surface of the battery cell body 10, a side surface, close to the battery cell body 10, of the edge banding 20 is an inner side surface 22, and a side surface, away from the battery cell body 10, of the edge banding 20 is an outer side surface 23. A first bonding body 30 is disposed on the cross section 21, and the first bonding body 30 wraps the cross section 21, a part of the inner side surface 22 of the edge banding 20, and a part of the outer side surface 23 of the edge banding 20. A lower edge of the first bonding body 30 on the inner side surface 22 is higher than a lower edge of the first bonding body 30 on the outer side surface 23, and a height of a side, away from the battery cell body 10, of the first bonding body 30 is greater than a height of a side, close to the battery cell body 10, of the first bonding body 30.

The packaging housing 80 includes two layers of aluminum-plastic films 81, and a cavity 82 for accommodating the battery cell body 10 is formed between the two layers of aluminum-plastic films 81. Each aluminum-plastic film 81 includes an insulating protective layer 811, a metal layer 812, and an insulating heat sealing layer 813, and the metal layer 812 is located between the insulating protective layer 811 and the insulating heat sealing layer 813. It is easily understood that the cross section 21 cut along a thickness direction of the edge banding 20 has the metal layer 812 exposed outside, and due to good electrical conductivity, the metal layer 812 may cause a short circuit of an external electronic component when being contacted with the external electronic component, thereby affecting the service life of the battery.

In the present application, the first bonding body 30 is disposed on the cross section 21 of the edge banding 20, and the first bonding body 30 fully wraps the cross section 21, so that the cross section 21 is insulated, avoiding a short circuit of an external electronic component caused by contact between the metal layer 812 exposed from the cross section 21 and obtained after cutting and the external electronic component, thereby improving insulation performance and safety during use. The first bonding body 30 is disposed on the cross section 21 of the edge banding 20 to improve the insulation performance, which can be applied to batteries of different shapes and modes. The first bonding body 30 wraps the cross section 21, a part of the inner side surface 22 of the edge banding 20, and a part of the outer side surface 23 of the edge banding 20, enhancing bonding stability of the first bonding body 30, and ensuring an insulating effect of the cross section 21.

A second bonding body 40 is provided between the inner side surface 22 of the edge banding 20 and the side surface of the battery cell body 10. In the present application, the second bonding body 40 is provided between the inner side surface 22 of the edge banding 20 and the side surface of the battery cell body 10, so that a bonding effect on the edge banding 20 is better, and fixing stability of the battery may be improved.

In the present application, the second bonding body 40 and the first bonding body 30 are used. For production of batteries of different modes, flexible production can be achieved, and during product changeover, it is not necessary to make too many adjustments on a binder coating device for forming the second bonding body 40 and the first bonding body 30, so that the product changeover is simple, thereby improving efficiency and convenience of the product changeover. In addition, in the present application, the second bonding body 40 is disposed between the inner side surface 22 of the edge banding 20 and a side surface of the battery cell body 10, and the first bonding body 30 is disposed on the cross section 21 of the edge banding 20, so that a problem of wrinkling of an adhesive paper does not occur compared with a method in the conventional technology that the insulating adhesive paper is applied to the edge banding 20.

As shown in FIG. 1 and FIG. 2, the first bonding body 30 is disposed on the cross section 21 of the edge banding 20, a side of the first bonding body 30 is close to the battery cell body 10, and the other side of the first bonding body 30 is away from the battery cell body 10 and exposed to the outside. In the present application, a lower edge of the first bonding body 30 on the inner side surface 22 is higher than a lower edge of the first bonding body 30 on the outer side surface 23, that is, a height of a side, away from the battery cell body 10, of the first bonding body 30 is greater than a height of a side, close to the battery cell body 10, of the first bonding body 30. Therefore, such a structure enables the side, exposed to the outside, of the first bonding body 30 to have a stronger abrasion resistance and adhesive force, so that the side, exposed to the outside, of the first bonding body 30 can be ensured to better wrap the cross section 21 of the edge banding 20, and an insulating effect of the cross section 21 can be ensured after long time use, thereby improving the service life and use stability of the battery.

As shown in FIG. 1 and FIG. 2, the edge banding 20 may be folded vertically upwards and extending along a side surface of the battery cell body 10, or may be folded upwards and extend in a shape of an arc or an oblique line or the like along a side surface of the battery cell body 10. The present application is not limited thereto.

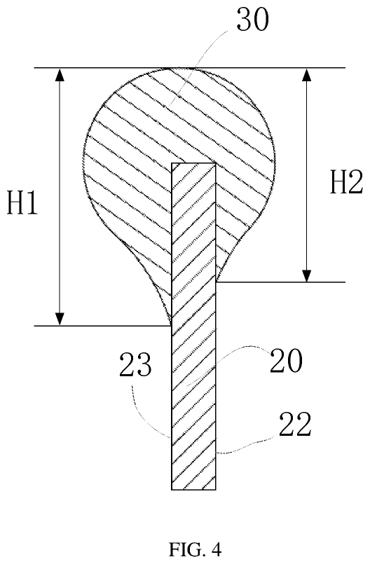

As shown in FIG. 4, in order to ensure adhesive strength of the first bonding body 30 disposed on the cross section 21 of the edge banding 20, and to ensure a stable insulating effect of the cross section 21 of the edge banding 20, a height difference between a top end of the first bonding body 30 and the lower edge of the first bonding body 30 on the outer side surface 23 is set to H1, and a numerical range of H1 is H1>0.05 mm. A height difference between the top end of the first bonding body 30 and the lower edge of the first bonding body 30 on the inner side surface 22 is H2, where a numerical range of H2 is H2>0.05 mm, and H2 is less than H1.

As shown in FIG. 4, one side of the first bonding body 30 disposed on the cross section 21 is close to the body, and the other side is exposed to the outside. Therefore, in order to ensure that the outer side, exposed to the outside, of the first bonding body 30 has a stronger abrasion resistance and adhesive force, the height difference H2 between a top position of the first bonding body 30 and the lowest contact position of the first bonding body 30 on the inner side surface 22 of the edge banding 20 is set to be less than the height difference H1 between the top position of the first bonding body 30 and the lowest contact position of the first bonding body 30 on the outer side surface 23 of the edge banding 20, that is, H2 is less than H1.

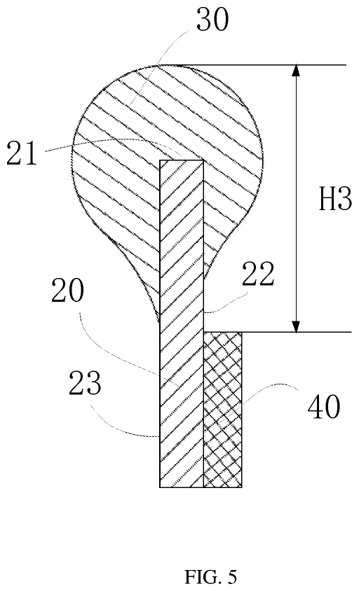

As shown in FIG. 5, in order to ensure that the cross section 21 of the edge banding 20 is insulated, the edge banding 20 does not occupy a width of the battery after being folded upwards, and a volume of the battery is reduced, it is required that after the edge banding 20 is folded upwards, a height of a top end of the first bonding body 30 is greater than a height of a top end of the second bonding body 40. It is easily understood that, a height difference H3 between a height of the top end of the first bonding body 30 and a height of the top end of the second bonding body 40 is greater than 0.

The lower edge of the first bonding body 30 on the inner side surface 22 is higher than the top end of the second bonding body 40, and/or the lower edge of the first bonding body 30 on the outer side surface 23 is higher than the top end of the second bonding body 40. In other words, the lower edge of the first bonding body 30 on the inner side surface 22 does not overlap the top end of the second bonding body 40, thereby preventing an excessive volume of the battery caused by an increase in the width of the first bonding body 30, and improving energy density of the battery.

As shown in FIG. 2, a height of the top end of the first bonding body 30 is lower than or equal to a height of a top surface of the battery cell body 10.

No matter whether the edge banding 20 extends vertically upwards or extends upwards in a shape of an arc along the battery cell body 10, the height of the top end of the first bonding body 30 is less than or equal to the height of the battery cell body 10, and a height difference H between the height of the battery cell body 10 and the height of the top end of the first bonding body 30 is greater than or equal to 0, so that it may be ensured that the energy density of the battery is not affected by an occupied large space and a large overall volume of the battery due to an excessively high height of the first bonding body 30.

It is easily understood that, for a square battery, the height of the battery cell body 10 refers to a height of an upper surface of the battery cell body 10; for a cylindrical battery, the height of the battery cell body 10 refers to a height of a top end of an arc of the battery cell body 10.

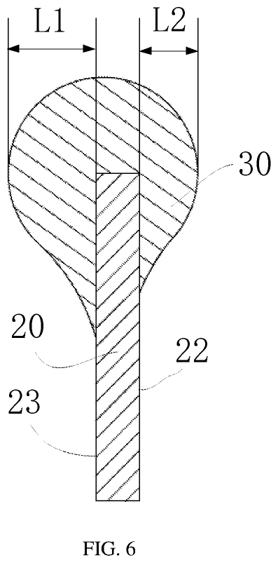

As shown in FIG. 6, a side, away from the battery cell body 10, of the first bonding body 30 is an outer side of the first bonding body 30, and a distance, in an orthographic projection direction of the battery cell body 10, from an outer side end of the first bonding body 30 to the outer side surface 23 of the edge banding 20 is L1, where a numerical range of L1 is 0<L1<0.3 mm. This ensures that the cross section 21 of the edge banding 20 is insulated, and a size of the first bonding body 30 does not affect the width of the battery, thereby helping to increase power density of the battery. The view direction shown in FIG. 2 is the orthographic projection direction of the battery cell body 10.

A side, close to the battery cell body 10, of the first bonding body 30 is an inner side of the first bonding body 30, and a distance, in the orthographic projection direction of the battery cell body 10, from an inner side end of the first bonding body 30 to the inner side surface 22 of the edge banding 20 is L2, where a numerical range of L2 is 0<L2<0.3 mm, and L1 is greater than L2. This ensures that the cross section 21 of the edge banding 20 is insulated, and a size of the first bonding body 30 does not affect the width of the battery, avoiding an excessive volume of the battery.

One side of the first bonding body 30 disposed on the cross section 21 is close to the body, and the other side is exposed to the outside. Therefore, in order to ensure that the outer side, exposed to the outside, of the first bonding body 30 has a stronger abrasion resistance and adhesive force, and the battery provided in the present application is more wear-resistant and more stable to increase use and transportation safety, and extend the service life, L1 is set to be greater than L2.

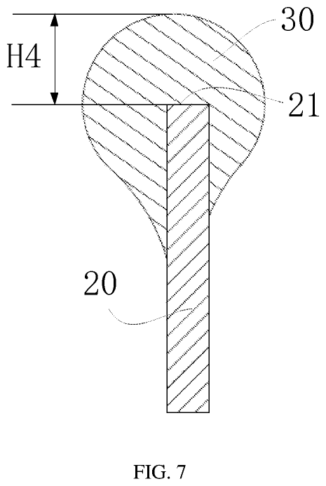

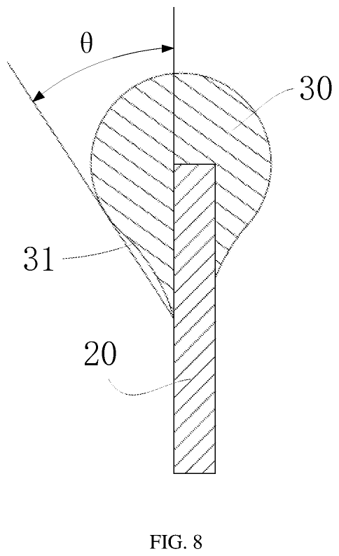

As shown in FIG. 7, in order to ensure that the cross section 21 of the edge banding 20 is insulated and the edge banding 20 does not exceed the height of the battery cell body 10 after the edge banding 20 is folded, a height of a top end of the first bonding body 30 is set to be greater than a height of the cross section 21 of the edge banding 20, and a height difference between the top end of the first bonding body 30 and the cross section 21 of the edge banding 20 is H4, where a numerical range of H4 is 0<H4<0.3 mm. This ensures a stable insulating effect of the cross section 21 of the edge banding 20, and the height of the first bonding body 30 does not exceed the height of the battery cell body 10, so that a height of the battery is optimized.

As shown in FIG. 8, in order to ensure that the first bonding body 30 does not collapse during dispensing, an angle between a lower edge 31 of a side, away from the battery cell body 10, of the first bonding body 30 and the edge banding 20 is set to θ, and a numerical range of the angle θ is 0<θ<90°.

Alternatively, a contact point between a lower end of the first bonding body 30 on the side away from the battery cell body 10 and the edge banding 20 may be set as a vertex, an outer tangent line from the vertex to the first bonding body 30 may be set as an edge line, and a side of the edge banding 20 may be set as the other edge line, to form an angle θ of a contact angle, where a numerical range of the angle θ is 0<θ<90°.

The first bonding body 30 is formed by curing a binder by using a method including, but not limited to, heating, moisture, air drying, light, or the like. In a possible implementation, the binder forming the first bonding body 30 is a flowing binder, for example, an insulating glue, a solid glue, a quick-drying glue, or the like. The binder forming the first bonding body 30 completely covers and wraps the cross section 21 of the edge banding 20, and then the first bonding body 30 is cured and shaped by heating, moisture, air drying, light, or the like, so that sealing strength of the cross section 21 of the edge banding 20 is higher.

In a possible implementation, a drawing force, along a direction perpendicular to the edge banding 20, between the first bonding body 30 and the edge banding 20 is greater than or equal to 0.01 kg/mm. The larger the drawing force, the stronger the wear resistance of the first bonding body 30.

A hardness of the first bonding body 30 is greater than 20 A (Shore hardness). The higher the hardness value, the stronger the wear resistance of the first bonding body 30.

The drawing force, along the direction perpendicular to the edge banding 20, between the first bonding body 30 and the edge banding 20 and the hardness of the first bonding body 30 collectively define the wear resistance of the first bonding body 30. The larger the drawing force, along the direction perpendicular to the edge banding 20, between the first bonding body 30 and the edge banding 20, the larger the hardness of the first bonding body 30, and the stronger the wear resistance of the first bonding body 30. In this way, it may be avoided that the first bonding body 30 is abraded to expose the metal layer 812 of the cross section 21 due to misoperation of the battery in a PACK process or a machine assembling process, or the like, thereby avoiding a short circuit of the battery and improving safety during use.

After the bonder forming the first bonding body 30 is applied and cured, a binder forming the second bonding body 40 is further applied, and the second bonding body 40 is formed by curing the binder by using a method including, but not limited to, heating, moisture, air drying, light, or the like. The binder forming the second bonding body 40 is a flowing double-sided adhesive binder, for example, an insulating glue, a solid glue, a quick-drying glue, or the like.

After the second bonding body 40 is disposed on the inner side surface 22 of the edge banding 20, the edge banding 20 is folded vertically upwards and extends along a height direction of the battery cell body 10 or folded upwards and extends in a circular arc shape along a side surface of the battery cell body 10, and then the binder forming the second bonding body 40 is cured and shaped by using a method such as heating, pressurization, moisture, air drying, or light, so that the edge banding 20 and the battery cell body 10 are bonded together.

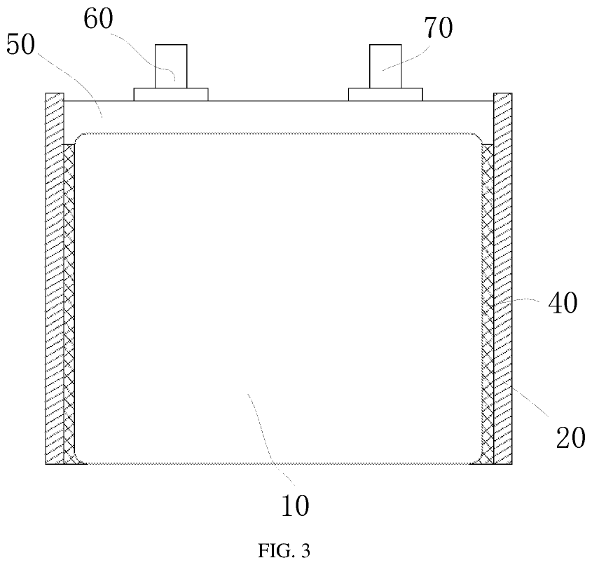

As shown in FIG. 3, the packaging housing 80 further has a top seal 50, the top seal 50 is configured to wrap a top surface of the battery cell body 10, a height of a top end of the first bonding body 30 is greater than a height of a top end of the top seal 50, and the first bonding body 30 covers a partial region of the top seal 50 and a partial region of the edge banding 20.

The battery cell body 10 includes a battery cell and a first electrode and a second electrode that are welded to the battery cell. The battery cell includes a positive electrode plate and a negative electrode plate. A coating is applied to front and back sides of a substrate of the positive electrode plate, and a coating is applied to front and back sides of a substrate of the negative electrode plate, and the battery cell is formed by winding the positive electrode plate and the negative electrode plate. One of the first electrode and the second electrode is a positive electrode, and the other is a negative electrode. A positive tab 60 is welded on the positive electrode, a negative tab 70 is welded on the negative electrode, and the positive tab 60 and the negative tab 70 extend from a top seal 50 of an aluminum-plastic film 81.

As shown in FIG. 9, the battery further includes an electrolyte filled in the cavity 82, and the battery cell body 10 is immersed in the electrolyte.

It should be noted that, the numerical values and numerical ranges in the present application are approximate values, and may have errors in a specific range due to an impact of a manufacturing process, but a person skilled in the art may consider these errors to be negligible.

In the descriptions of the present application, it should be understood that the orientations or positional relationships indicated by the terms “center”, “length”, “width”, “thickness”, “top”, “bottom”, “upper”, “lower”, “left”, “right”, “front”, “back”, “vertical”, “horizontal”, “inner”, “outer”, “axial”, “circumferential”, and the like are based on the orientations or positional relationships shown in the accompanying drawings. Such terms are merely intended to facilitate the descriptions of the present application and simplify the descriptions, without indicating or implying that the positions or components mentioned in the present application must have specific orientations, or be constructed and operated in a specific orientation, and therefore shall not be construed as a limitation to the present application.

In addition, the terms “first”, “second”, and the like are merely intended for a purpose of description, and shall not be understood as an indication or implication of relative importance or implicit indication of the number of indicated technical features. Therefore, the features defined by “first”, “second”, and the like may indicate or imply that one or more of the features are included. In the description of the present application, “a plurality of” means at least two, for example, two or three, unless otherwise explicitly and specifically defined.

In the present application, unless specified and defined explicitly otherwise, the terms “mounted”, “join”, “connect”, “fixed”, and the like should be understood in a broad sense. For example, “connection” may be a fixed connection, a detachable connection, or an integral connection; or may be a mechanical connection, an electrical connection, or a mutual communication; or may be a direct connection or an indirect connection by means of an intermediate medium; or may be an internal communication or an interactive relationship between two elements. Persons of ordinary skill in the art may understand specific meanings of these terms in the present application based on specific situations.

In the present application, unless specified and defined explicitly otherwise, the expression that the first feature is “on” or “below” the second feature may include that the first feature is in direct contact with the second feature, or may include that the first feature and the second feature are not in direct contact with each other, but are contacted via another feature formed therebetween. Moreover, that the first feature is “above”, “over”, and “on” the second feature includes that the first feature is directly above or obliquely above the second feature, or merely indicates that the first feature is higher than the second feature in horizontal height. That the first feature is “below”, “under” and “beneath” the second feature includes that the first feature is directly below or obliquely below the second feature, or simply indicates that the first feature is lower than the second feature in horizontal height.

Finally, it should be noted that the foregoing embodiments are merely intended for describing the technical solutions of the present application but not for limiting the present application. Although the present application is described in detail with reference to the foregoing embodiments, persons of ordinary skill in the art should understand that they may still make modifications to the technical solutions described in the foregoing embodiments or make equivalent replacements to some or all technical features thereof without departing from the scope of the technical solutions of the embodiments of the present application.

What is claimed is:

1. A battery, comprising: a battery cell body and a packaging housing, the packaging housing having an edge banding and a cavity for accommodating the battery cell body, and the edge banding having a cross section cut along a thickness direction of the edge banding, wherein
the edge banding extends upwards along a side surface of the battery cell body, a side surface, close to the battery cell body, of the edge banding is an inner side surface, a side surface, away from the battery cell body, of the edge banding is an outer side surface, the cross section is provided with a first bonding body, the first bonding body wraps the cross section, a part of the inner side surface of the edge banding, and a part of the outer side surface of the edge banding, and a lower edge of the first bonding body on the inner side surface is higher than a lower edge of the first bonding body on the outer side surface.

2. The battery according to claim 1, wherein a second bonding body is provided between the inner side surface of the edge banding and the side surface of the battery cell body.

3. The battery according to claim 2, wherein the lower edge of the first bonding body on the inner side surface is higher than a top end of the second bonding body.

4. The battery according to claim 2, wherein the lower edge of the first bonding body on the outer side surface is higher than a top end of the second bonding body.

5. The battery according to claim 2, wherein the lower edge of the first bonding body on the inner side surface is higher than a top end of the second bonding body; and
the lower edge of the first bonding body on the outer side surface is higher than the top end of the second bonding body.

6. The battery according to claim 2, wherein the second bonding body is formed by curing a binder by means of heating, moisture, air drying, or light.

7. The battery according to claim 1, wherein a height difference between a top end of the first bonding body and the lower edge of the first bonding body on the outer side surface is H1, and a numerical range of H1 is H1>0.05 mm.

8. The battery according to claim 7, wherein a height difference between the top end of the first bonding body and the lower edge of the first bonding body on the inner side surface is H2, wherein a numerical range of H2 is H2>0.05 mm, and H2 is less than H1.

9. The battery according to claim 1, wherein a side, away from the battery cell body, of the first bonding body is an outer side of the first bonding body, a distance, in an orthographic projection direction of the battery cell body, from an outer side end of the first bonding body to the outer side surface of the edge banding is L1, and a numerical range of L1 is 0<L1<0.3 mm.

10. The battery according to claim 9, wherein a side, close to the battery cell body, of the first bonding body is an inner side of the first bonding body, a distance, in the orthographic projection direction of the battery cell body, from an inner side end of the first bonding body to the inner side surface of the edge banding is L2, wherein a numerical range of L2 is 0<L2<0.3 mm, and L1>L2.

11. The battery according to claim 1, wherein a height of a top end of the first bonding body is lower than or equal to a height of a top surface of the battery cell body.

12. The battery according to claim 1, wherein a height of a top end of the first bonding body is greater than a height of the cross section of the edge banding, and a height difference between the top end of the first bonding body and the cross section of the edge banding is H4, wherein a numerical range of H4 is 0<H4<0.3 mm.

13. The battery according to claim 1, wherein an angle between a lower edge of a side, away from the battery cell body, of the first bonding body and the edge banding is θ, and a numerical range of the angle θ is 0<θ<90°.

14. The battery according to claim 1, wherein the packaging housing further has a top seal, the top seal is configured to wrap a top surface of the battery cell body, a height of a top end of the first bonding body is greater than a height of a top end of the top seal, and the first bonding body covers a partial region of the top seal.

15. The battery according to claim 1, wherein a drawing force, along a direction perpendicular to the edge banding, between the first bonding body and the edge banding is greater than or equal to 0.01 kg/mm.

16. The battery according to claim 1, wherein a hardness of the first bonding body is greater than 20 A.

17. The battery according to claim 1, wherein the first bonding body is a binder cured by means of heating, moisture, air drying, or light, and the first bonding body has a shape of water drop, circle, oval, square, or U-shaped.

18. The battery according to claim 1, wherein the battery comprises a lithium battery.
